(19) United States
(12) Patent Application Publication
(10) Pub. No.: US 2018/0064103 A1
(43) Pub. Date: Mar. 8, 2018

(54) SURFACTANTS THAT IMPROVE THE STABILITY OF AGRICHEMICAL SEED TREATMENT FORMULATIONS AND CUSTOM BLENDS AND REDUCE THEIR VISCOSITY AND DUSTING OFF PROPERTIES

(71) Applicants: John M. Moyer, IV, Walnutport, PA (US); Justin Seckel, Platte City, MO (US); Bradley Merritt Swillin, Easley, SC (US); Christopher Robert Welch, Greer, SC (US)

(72) Inventors: John M. Moyer, IV, Walnutport, PA (US); Justin Seckel, Platte City, MO (US); Bradley Merritt Swillin, Easley, SC (US); Christopher Robert Welch, Greer, SC (US)

(21) Appl. No.: 15/216,406

(22) Filed: Jul. 21, 2016

Related U.S. Application Data
(60) Provisional application No. 62/195,481, filed on Jul. 22, 2015.

(51) Int. Cl. A01N 25/30

(52) U.S. Cl. CPC A01N 25/30

(57) ABSTRACT

Many pesticide, insecticide or fertilizer-type formulations prove beneficial when applied to a seed prior to planting. However, when mixing multiple formulations simultaneously in a custom blend, problems arise regarding the viscosity and stability of the blend that result in inadequate handling, coverage and stability. Further, dusting off of certain pesticides must be minimized. The present invention comprises the addition of specific surfactants to the custom blend formulation to manage viscosity, thus improving pumpability, seed coverage, and stability of custom blends while reducing seed dust off.

### CROSS-REFERENCE TO RELATED APPLICATIONS

This application claims the benefit of U.S. Provisional Application No. 62/195,481 filed Jul. 22, 2015.

### FIELD OF THE INVENTION

Non-pesticide formularies for seed treatments generally include material such as surfactants, humectants, fillers, and polymers that influence the treated seed characteristics. In an effort to provide seeds pretreated for the purpose of resisting pests and insects, various means have been employed to bind the active ingredient to the seed in such a way that allows even and predictable loading onto the seed. Further, the bound ingredient must be reasonably active, usually over a period of time and over a given space around the seed which means the ingredient must be released in a generally predictable manner. Seed treatments for these purposes have been developed. However, many such seed treatments have yet to adequately address the problem of “dusting off” which occurs as the seeds are transported, poured, and applied while maintaining the desired characteristics of the specific application. A new seed treatment was needed that could address both the dusting off issues as well as provide a vehicle for accurately binding active ingredient to the seed, and releasing it as needed.

### BACKGROUND OF THE INVENTION

The practice of treating seed with pesticide formulations is well known. Fungicides and Insecticides are applied to crop seeds separately or in combination to protect them from pests in the soil and throughout the early growing stages. Four types of formulations are widely used;

1. aqueous flowables (suspension concentrates) which typically include aqueous concentrated compositions of solid particulate water insoluble substances which flow as viscous liquids;

2. wettable powders, which, when mixed with water do not dissolve but, instead, form a suspension; and

3. granular form which may include water dispersible granules or extruded granules; and

4. water dispersible granules which are like wettable powders except instead of being dust-like, they are formulated as small, easily measured granules which are mixed with water to be applied or may be applied dry with water applied secondly. Once in water, water dispersible granules break apart into fine particles similar to wettable powders. If mixed with water, a water-dispersible granular formulation typically requires constant agitation to keep the granules suspended in water. The percentage of active ingredient can be high, sometimes as much as 90 percent by weight. Water-dispersible granules share many of the same advantages and disadvantages of wettable powders except they are more easily measured and mixed, and pose less inhalation hazard to the applicator during handling.

In common circumstances, pesticide formulations for seed treatments are mixed together with one another in addition to binding agents, flow agents, and colorants. Binding agents are used to cause the formulation to bind together upon drying on a surface to which the formulation is applied, similar to paint. Whereas, flow agents are additives included in powdered or granulated material to prevent the formation of lumps (caking). Water-soluble polymer coatings, water-insoluble but water-sensitive seed coatings that disintegrate when contacted with water, and non-phytotoxic polymer-based film coatings which may or may not also include lubrication are known. Seed treatments may even include plant seed-binding protein. These types of formulations may be commonly known as “Custom Blends.” Under 40 CFR Subchapter E Part 167 Subpart A 167.3, Custom Blends are referred to as a mixture containing pesticides made to a customer's specifications. A Custom Blend usually comprises a pesticide(s)-fertilizer(s) mixture, a pesticide-pesticide mixture, or a pesticide-animal feed mixture.”

When blending and producing Custom Blends, several issues arise from highly loaded active ingredient concentrations of several suspension concentrate, wettable powder, and granular formulations. These highly loaded concentrations result in high percent weight by weight solids which, in turn, may cause incremental increase in viscosity and decreased stability. Both commercial seed treatment formulations and Custom Blends of increased viscosity require the use of specialized and mechanically diversified equipment in order to move, package, and evenly apply the seed treatments. Appropriate handling and pumping of formulations, Custom Blends and slurries becomes critical to ensure uniform seed coverage.

Although seed treatment is applied to the seeds in a manner that encourages the treatment to adhere to the seed, application is not perfect and various conditions can affect the level of adherence to the seed. Those conditions include; the level of moisture in the storage area or during application, the length of time the treated seed is stored, the manner of seed handling, and, of course, the properties of the seed treatment itself. A certain amount of the treatment will invariably become dissociated from the seed and become what is referred to as “dust off”. The rate at which this occurs per kernel is referred to as “dusting off” or the “dust off rate”

An issue relating to Custom Blends and/or the viscous liquid agrichemical compositions applied as seed treatments has arisen in recent years. There is a perception that the use of the Neonicotinoid class of insecticides is linked to the bee pollinator colony collapse around the world. As a result, a standard “dust off rate” has been broadly accepted based upon The EUROPEAN COMMISSION HEALTH AND CONSUMERS DIRECTORATE-GENERAL Directorate E—Safety of the food chain Unit E.3—Chemicals, contaminants, pesticides, SANCO/10553/2012 rev. 8 Mar. 2012. This document contains information on the European Union allowable level of seed treatment dust and establishes 0.75 grams/100,000 kernels of maize as an upper acceptable level. In the U.S., this level has been widely accepted and is the base target for dusting off formulation improvements.

There is, therefore, a demand for higher quality seed treatment formulations and custom blends that do not have a high viscosity, are more stable, have less dust off and are not phytotoxic to the seed.

### SUMMARY OF INVENTION

The present invention concerns liquid agrichemical compositions for use as or in conjunction with seed treatments to achieve improved viscosity, stability, and processes for making such compositions. The compositions contain active ingredients from multiple classes of chemistries with one or more surfactants that reduce the viscosity of formulations and include blends that surprisingly lead to reduced viscosity, improved stability, and handling. The novel inventive compositions have proved to have a lower and acceptable viscosity, improved stability, and improved suspension properties in dilution. Furthermore, these surfactants have unexpectedly reduced seed dust off, especially with Neonicotinoid Insecticides.

The subject invention pertains to providing seed treatments having improved: viscosity profile, stability and seed safety of liquid pesticide formulations, which comprise the following:
1. At least one surfactant that reduces the viscosity profile, increases the stability, and retains germination rates of the seed when used at between about 0.10% and about 10.00% w/w. The surfactants preferably do not cause independent physical or biological damage to seed.
2. A formulation or Custom Blend of one or more pesticides that are in the form of a suspension concentrate, wettable powder or granule and contain an active ingredient content of 0.50-99.00% w/w which contain the surfactant at between about 0.10% and about 10.00% w/w. Optionally, other additives such as polymers, colorants, fertilizers, or bio-stimulants may be combined with the seed treatment custom blend. Co-emulsifiers and/or additional surfactant may also be included.
3. Seed dust off around or, preferably, below 0.75 grams/100,000 kernels of maize, especially with the Neonicotinoid Insecticides.

### BRIEF DESCRIPTION OF THE FIGURES

FIG. 1 Example structures of surfactants suitable for use with the inventive seed treatment

FIG. 2 Example structures of surfactants suitable for use with the inventive seed treatment;

FIG. 3 Example structures of surfactants suitable for use with the inventive seed treatment;

FIG. 4A-4D Example structures of surfactants suitable for use with the inventive seed treatment;

FIG. 5A-5D Example structures of surfactants suitable for use with the inventive seed treatment;

FIG. 6A-6D Example structures of surfactants suitable for use with the inventive seed treatment;

FIG. 7A-7C Example structures of surfactants suitable for use with the inventive seed treatment;

FIG. 8A-8B Example structures of surfactants suitable for use with the inventive seed treatment;

FIG. 9A-9C Example structures of surfactants suitable for use with the inventive seed treatment.

FIG. 10A-10D Example structures of surfactants suitable for use with the inventive seed treatment.

FIG. 11 Example structures of surfactants suitable for use with the inventive seed treatment.

### DETAILED DESCRIPTION

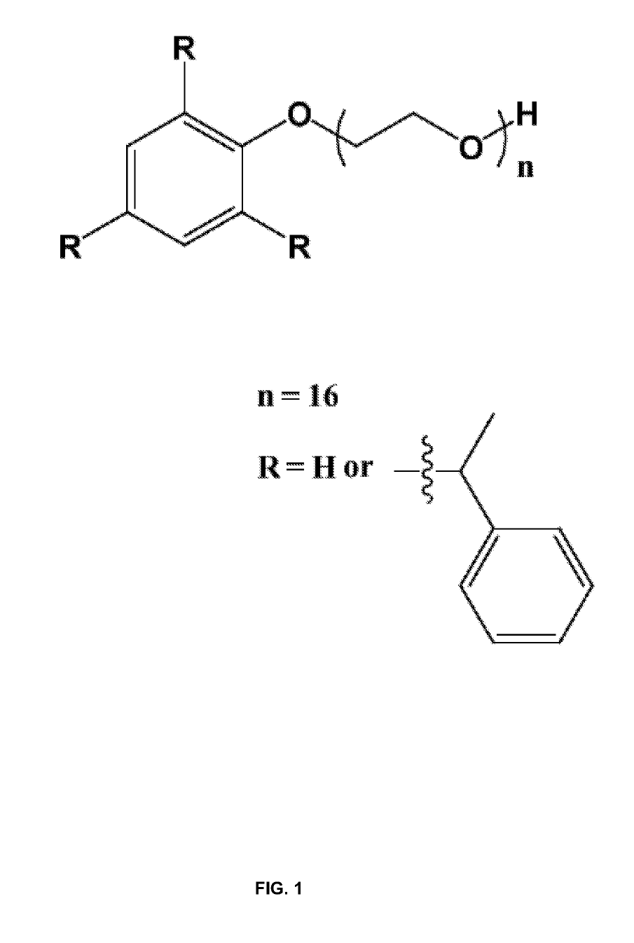

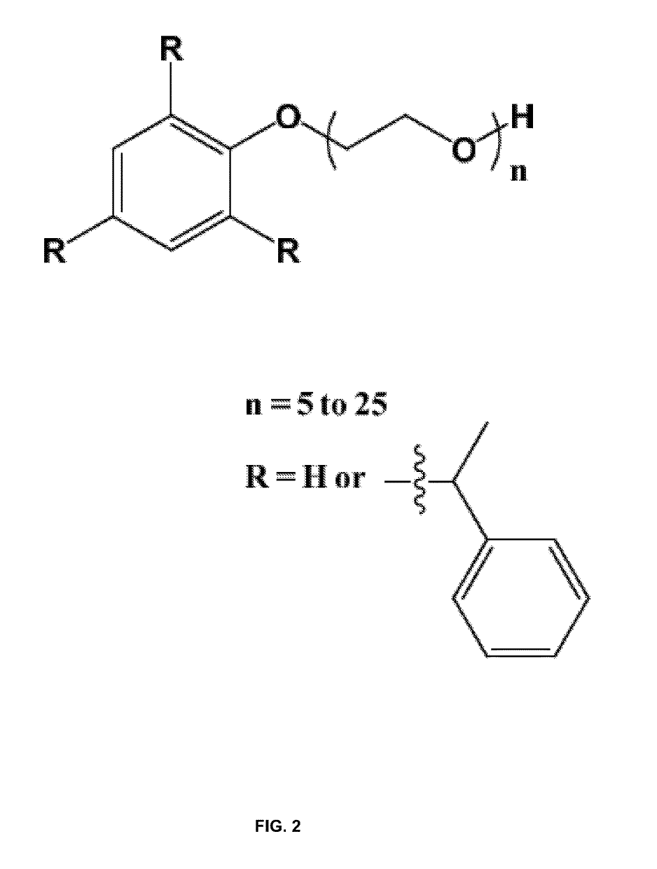

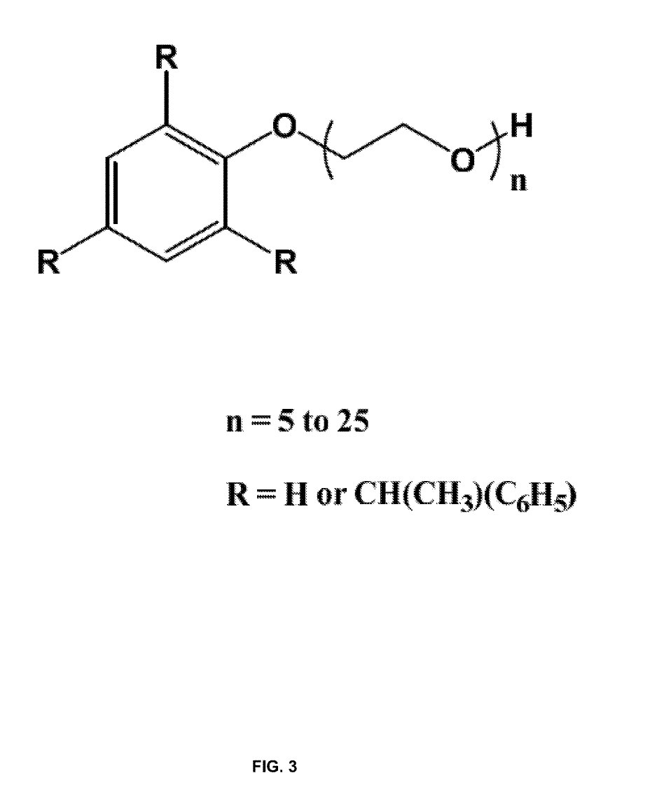

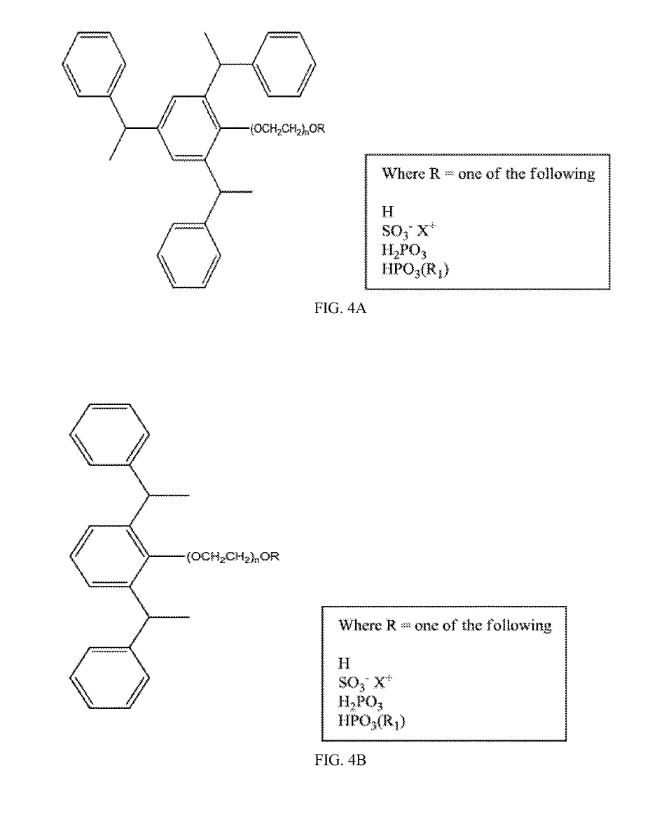

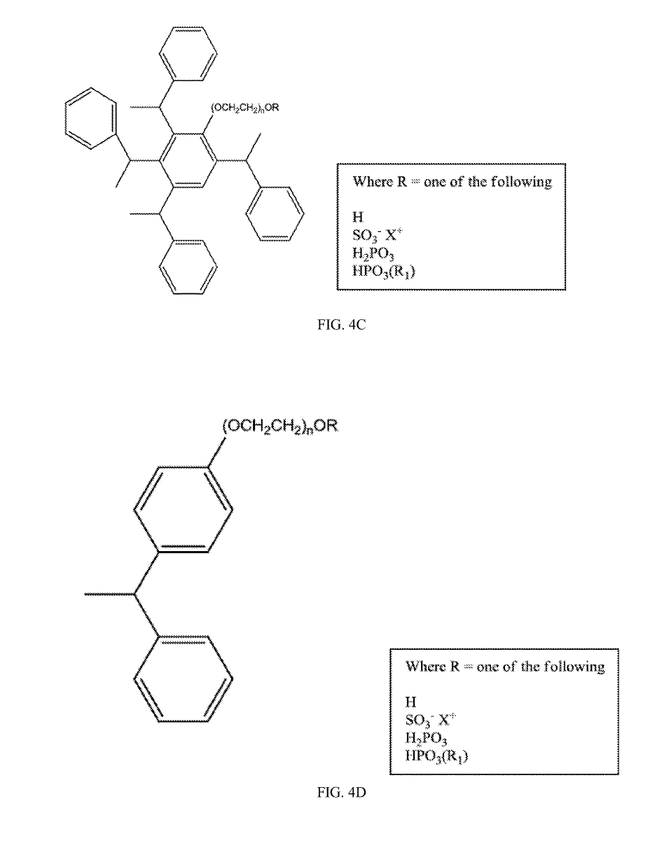

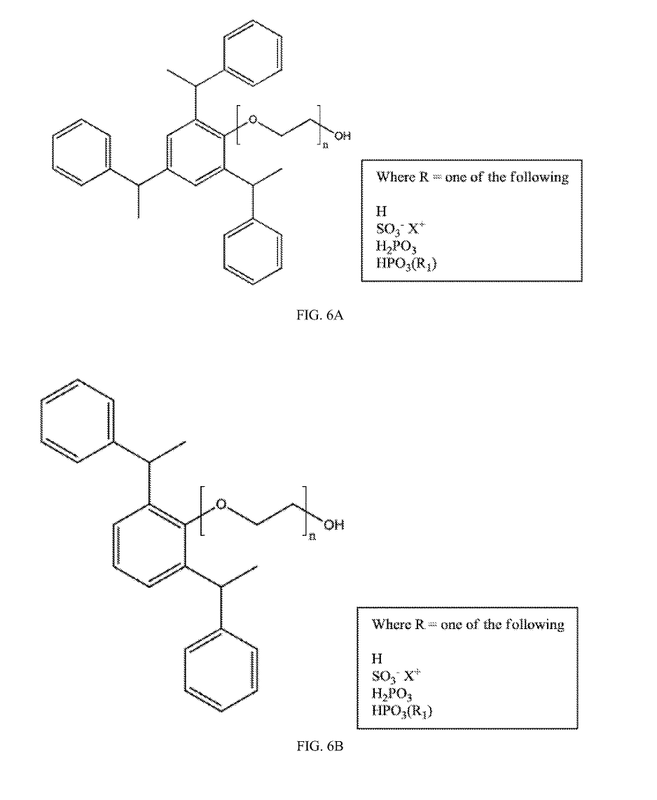

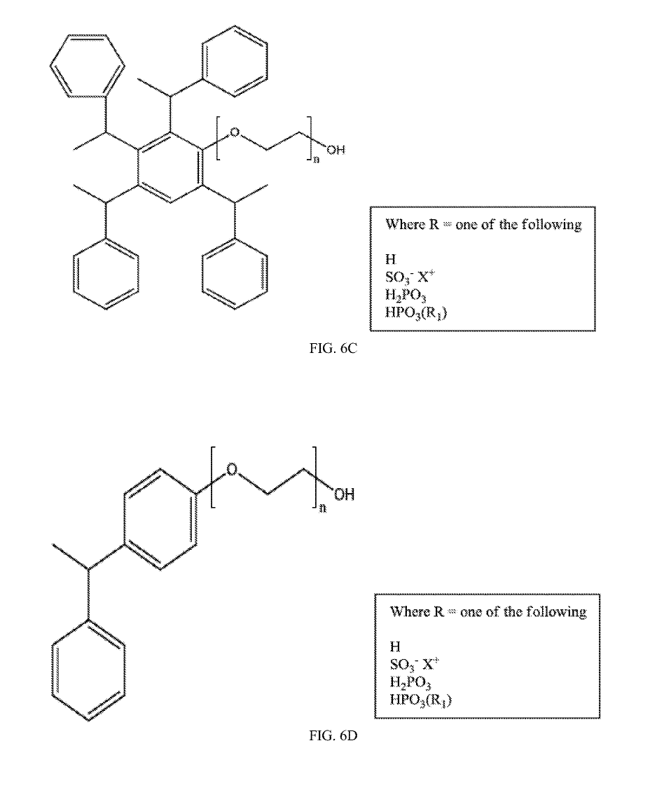

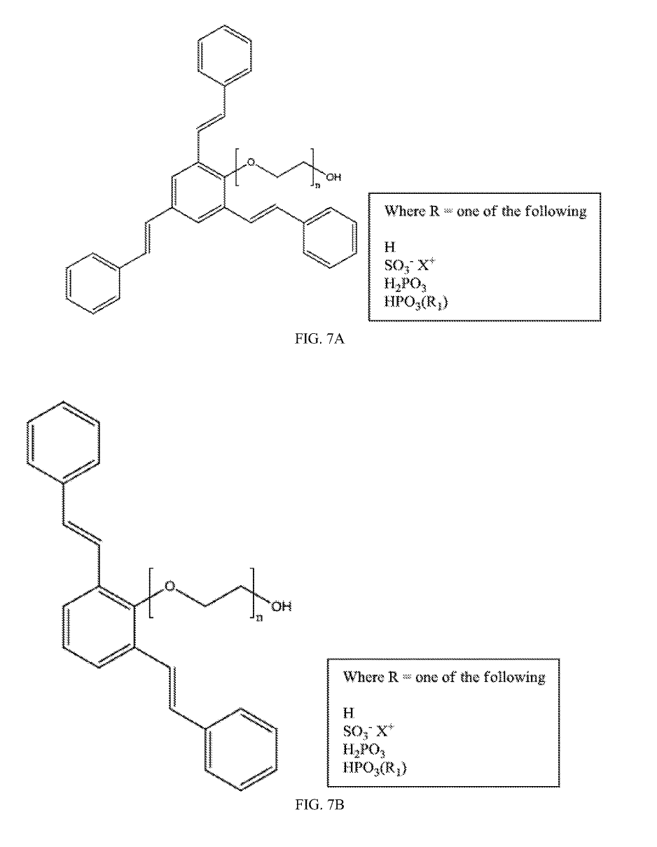

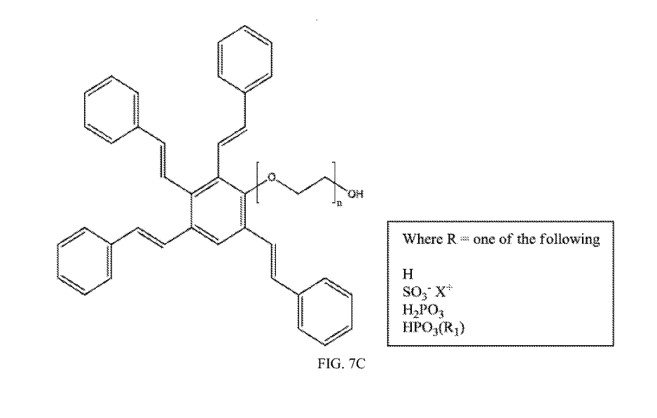

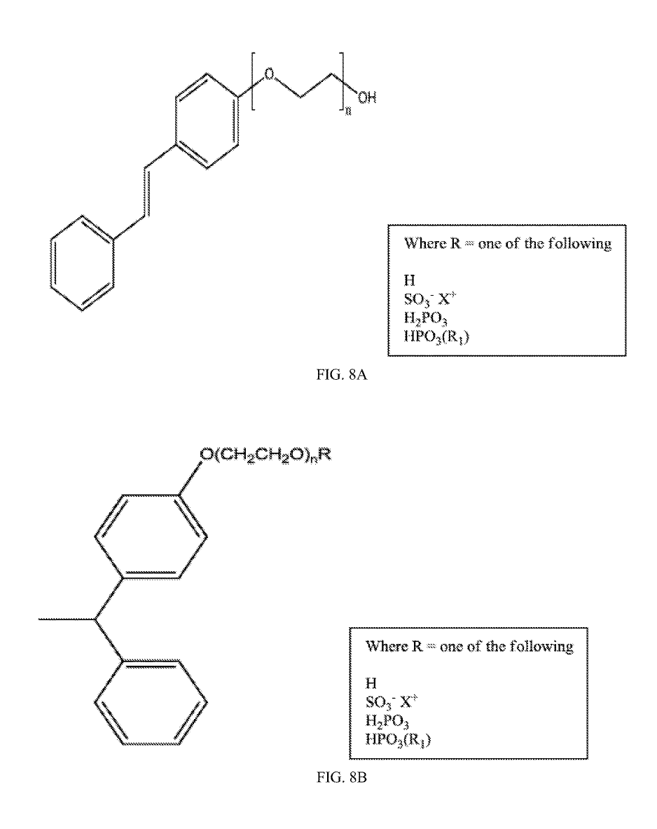

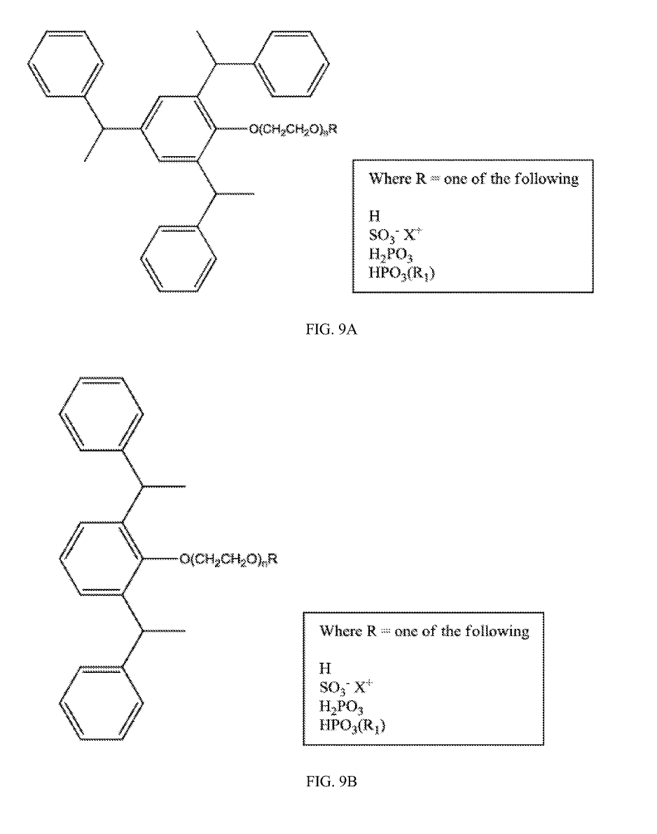

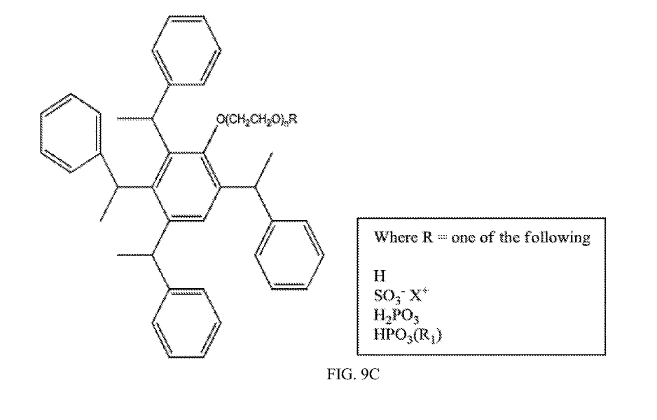

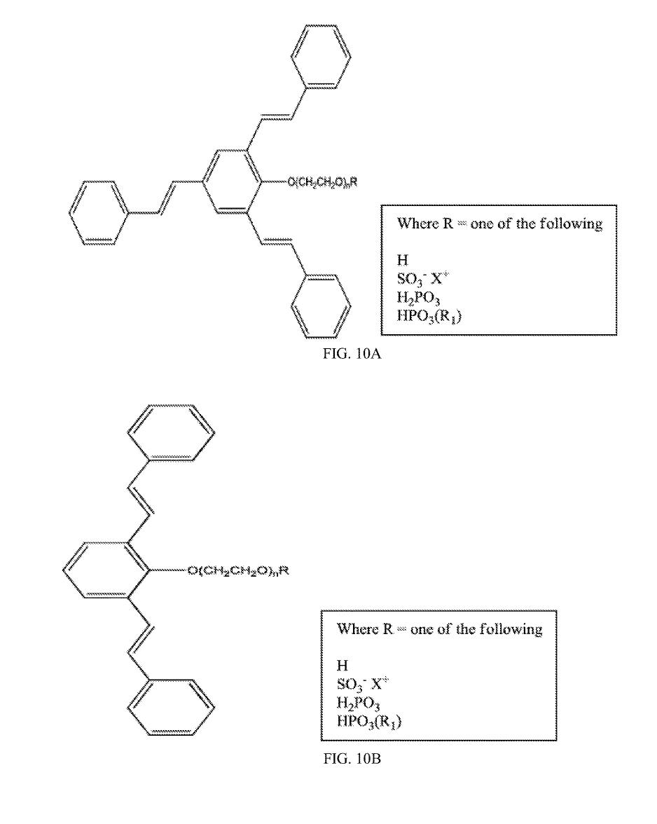

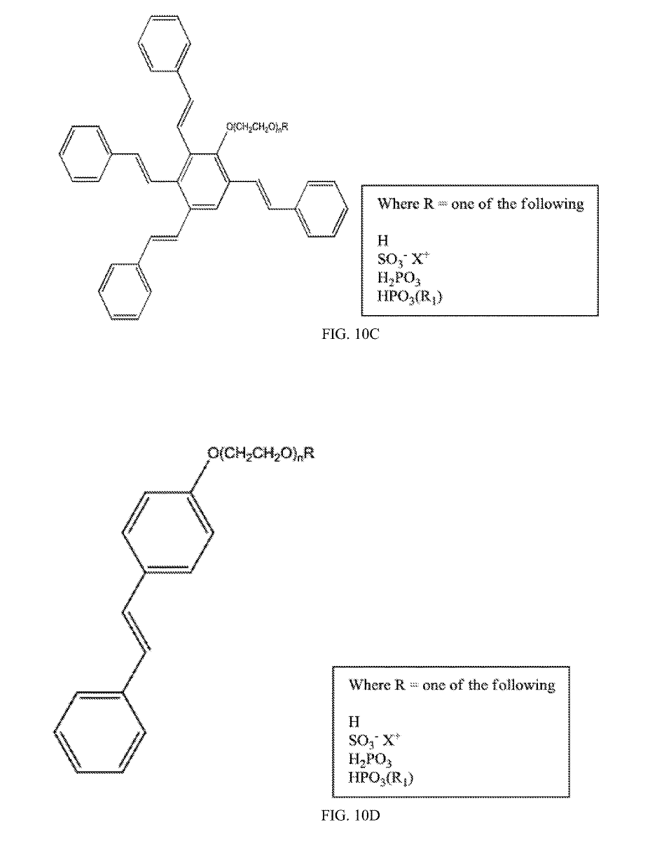

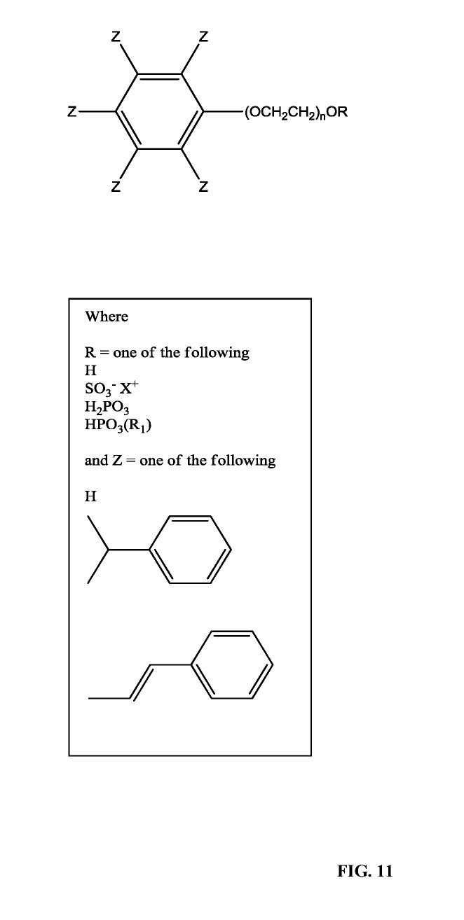

The present invention addresses a seed treatment formulation which comprises at least one surfactant. The at least one surfactant (identified in the Figs. as “ALB100”) may include a mixture of polyoxyethylated alkaryls, or mixed alkaryl ethoxylates and, as a particular example, may comprise ethoxylated styrenated phenol alkoxylate, polyarylphenol ethoxylates, ethoxylated polyphenyl ether phosphate and their salts and alkylated tristyrlphenols which are generally referred to as Tristyrylphenol ethoxylates (see exemplary structures at FIGS. 1-11). The surfactant may also consist of or comprise mono-, di-, or tri-styrenated phenols and mixtures thereof. The seed treatment of the present invention comprises lower viscosity than seed treatments without the subject surfactant and exhibits dust off rates well within the accepted limits, all without statistically compromising seed germination rates as shown at Tables 13-23 herein, yet, increasing stability of the seed treatment.

Measurement Methods:

Stability—Stability is defined in the subject invention as a seed treatment formulation/custom blend that exhibits little or no visible bleed layer (i.e. a layer containing little or no suspended or dispersed solid particles) after a specified period of time and the ability of the finished products or blends to be agitated to re-disperse this layer.

Viscosity—Viscosity measurements of exemplary subject seed treatment formulations are presented in Tables 1-12 in Centipoise (cP) and were generated using a Brookfield DV-II+ viscometer. All measurements were taken at 20 C, in a 600 ml glass or stainless steel beaker with the #2 Spindle at 12 Revolutions per minute. Viscosity measurements using these parameters are limited to viscosities of less than 3300 cPs. According to this invention, acceptable viscosity readings range from 1 to about 2500 cPs. Seed treatment formulations having viscosity higher than about 2500 cPs were deemed difficult to handle commercially but, even so, are considered to be within the purview of this disclosure. Tables 1-12 present viscosity.

Method for Agitation—It has become apparent during the research and development underlying this invention that high shear mixing provides the level of agitation and uniform mixing desirable for the subject formulations and custom blends. Means for achieving acceptable uniformity include a Silverson mixer or other means of high shear to adequately disperse, or transport, one phase or ingredient (liquid, solid, gas) into a main continuous phase (liquid), with which it would normally be immiscible.

Evaluating Dust Off—Seed treatment formulations and controls were applied to seed utilizing a Hege batch treater. Two 100 g seed samples were run through the Heubach Dustmeter. Temperature and relative humidity at time of evaluation were recorded and required to fall within a specified range for measurement consistency (control) purposes. A seed count also was performed to determine the mean grams of dust per 100,000 seed. Dust off levels are presented at Table 18 herein.

Examples of Inventive Formulations & Data:

Seed treatment formulations of the present invention reduce viscosity (see Tables 1-12 below and include components as described below in weight by weight expression, with the amount of surfactant as disclosed herein serving as the variable.

The chemical structures of acceptable surfactants of the present invention are shown at FIGS. 1-11. The samples ranged from a control sample with no surfactant up to a little more than 5%, however, the invention contemplates the use of surfactant up to about 10% w/w surfactant. The viscosity and amount of surfactant meeting the characteristics disclosed herein were generally inversely related, as expected. The level of viscosity was measured over time and it was determined that the increase in the viscosity over time in samples where surfactant was present was far less than expected when no surfactant was employed.

TABLE 1
(w/w %)

| | Sample 1 | Sample 2 | Sample 3 | Sample 4 | Sample 5 |
|---|---|---|---|---|---|
| Fludioxonil 4.0 ST | 2.16 | 2.15 | 2.14 | 2.14 | 2.13 |
| Metalaxyl 4.0 ST | 13.48 | 13.44 | 13.40 | 13.38 | 13.33 |
| T-Methyl ST | 7.55 | 7.53 | 7.51 | 7.49 | 7.47 |
| Imidacloprid 600 ST | 43.13 | 43.01 | 42.90 | 42.80 | 42.67 |
| Keystone Treating Solutions Red | 20.22 | 20.16 | 20.11 | 20.06 | 20.00 |
| Colorant | | | | | |
| Keystone Solutions Soybean | 13.48 | 13.44 | 13.40 | 13.38 | 13.33 |
| Polymer 604 | | | | | |
| Surfactant | 0.00 | 0.27 | 0.54 | 0.749 | 1.07 |
| Viscosity (initial) | 1220 | 1100 | 1027 | 1133 | 817 |
| Viscosity (30 days) | 1670 | 1263 | 1127 | 1447 | 950 |
| Viscosity (60 days) | 3134 | 1760 | 1303 | 1460 | 873.3 |

TABLE 2
(w/w %)

| | Sample 1 | Sample 2 | Sample 3 | Sample 4 | Sample 5 |
|---|---|---|---|---|---|
| Thiabendazole 4.0 ST | 2.28 | 2.27 | 2.26 | 2.26 | 2.25 |
| Metalazyl 4.0 ST | 14.22 | 14.19 | 14.15 | 14.12 | 14.08 |
| Rancona 3.8 | 2.42 | 2.41 | 2.41 | 2.40 | 2.39 |
| Imidacloprid 600 ST | 45.52 | 45.42 | 45.29 | 45.17 | 45.07 |
| Keystone Solutions Red Colorant | 21.34 | 21.29 | 21.23 | 21.17 | 21.13 |
| Keystone Solutions Soybean | 14.22 | 14.19 | 14.15 | 14.12 | 14.08 |
| Polymer 604 | | | | | |
| Surfactant | 0.00 | 0.23 | 0.51 | 0.76 | 0.99 |
| Viscosity (initial) | EEEE | EEEE | 2923 | 1197 | 1140 |
| Viscosity (30 days) | EEEE | EEEE | 2930 | 1800 | 1160 |
| Viscosity (60 days) | EEEE | EEEE | EEEE | 2070 | 1380 |

TABLE 3
(w/w %)

| | Sample 1 | Sample 2 | Sample 3 | Sample 4 | Sample 5 | Sample 6 | Sample 7 |
|---|---|---|---|---|---|---|---|
| Fludioxonil 4.0 ST | 7.41 | 7.39 | 7.37 | 7.35 | 7.33 | 7.25 | 7.18 |
| Metalaxyl 4.0 ST | 46.30 | 46.17 | 46.08 | 45.96 | 45.83 | 45.33 | 44.88 |
| Keystone | 46.30 | 46.17 | 46.08 | 45.96 | 45.83 | 45.33 | 44.88 |
| Solutions Red | | | | | | | |
| Colorant | | | | | | | |
| Surfactant | 0.00 | 0.277 | 0.461 | 0.735 | 1.008 | 2.085 | 3.052 |
| Viscosity (initial) | 610 | 640 | 663 | 663 | 670 | 730 | 800 |
| Viscosity (30 | 1060 | 1047 | 1027 | 986.7 | 986.7 | 926.7 | 923.3 |
| days) | | | | | | | |
| Viscosity (60 | 1057 | 1070 | 980 | 983.3 | 990 | 923.3 | 987 |
| days) | | | | | | | |

TABLE 4
(w/w %)

| | Sample | Sample | Sample | Sample | Sample | Sample | Sample |
|---|---|---|---|---|---|---|---|
| | 1 | 2 | 3 | 4 | 5 | 6 | 7 |
| Macho 480 ST | 65.44 | 65.28 | 65.11 | 64.95 | 64.78 | 64.13 | 63.64 |
| Rizolex | 7.62 | 7.60 | 7.58 | 7.57 | 7.55 | 7.47 | 7.41 |
| Metalaxyl 4.0 ST | 4.39 | 4.38 | 4.37 | 4.36 | 4.35 | 4.31 | 4.27 |
| Myclobutanil 240 ST | 1.10 | 1.10 | 1.09 | 1.09 | 1.09 | 1.08 | 1.07 |
| Azoxystrobin 9.6 FL | 2.01 | 2.01 | 2.00 | 2.00 | 1.99 | 1.97 | 1.96 |
| Surfactant | 0.000 | 0.251 | 0.504 | 0.748 | 1.004 | 2.004 | 2.752 |
| Keystone Solutions | 1.18 | 1.18 | 1.18 | 1.17 | 1.17 | 1.16 | 1.15 |
| Soybean Polymer 604 | | | | | | | |
| Acephate 97% | 18.25 | 18.20 | 18.16 | 18.11 | 18.07 | 17.88 | 17.75 |
| Viscosity (initial) | 1290 | 1167 | 963 | 863 | 860 | 972 | 1003 |
| Viscosity (30 days) | 1470 | 1363 | 1317 | 1310 | 1227 | 1177 | 1087 |
| Viscosity (60 days) | 1023 | 886.7 | 1027 | 1117 | 910 | 820 | 640 |

TABLE 5
(w/w %)

| | 1 | 2 | 3 | 4 | 5 | 6 | 7 | 8 | 9 |
|---|---|---|---|---|---|---|---|---|---|
| Metalaxyl 4.0 ST | 5.94 | 5.92 | 5.91 | 5.89 | 5.88 | 5.82 | 5.76 | 5.70 | 5.64 |
| Fludioxonil 4 L ST | 0.24 | 0.24 | 0.24 | 0.24 | 0.24 | 0.23 | 0.23 | 0.23 | 0.23 |
| Myclobutanil | 11.88 | 11.85 | 11.82 | 11.79 | 11.76 | 11.64 | 11.52 | 11.40 | 11.27 |
| 240 ST | | | | | | | | | |
| Difenoconazole | 5.94 | 5.92 | 5.91 | 5.89 | 5.88 | 5.82 | 5.76 | 5.70 | 5.64 |
| 3 L ST | | | | | | | | | |
| Macho 600 ST | 76.01 | 75.82 | 75.63 | 75.44 | 75.25 | 74.49 | 73.73 | 72.98 | 72.15 |
| Surfactant | 0.00 | 0.25 | 0.50 | 0.75 | 1.00 | 2.00 | 3.00 | 3.99 | 5.07 |
| Viscosity (initial) | EEEE | EEEE | EEEE | EEEE | EEEE | EEEE | 2390 | 1333 | 897 |
| Viscosity (30 | EEEE | / | / | / | / | / | EEEE | 2210 | 1083 |
| days) | | | | | | | | | |
| Viscosity (60 | EEEE | / | / | / | / | / | EEEE | 2230 | 1513 |
| days) | | | | | | | | | |

TABLE 6
(w/w %)

| | Sample | Sample | Sample | Sample | Sample | Sample | Sample |
|---|---|---|---|---|---|---|---|
| | 1 | 2 | 3 | 4 | 5 | 6 | 7 |
| Macho 600 ST | 10.87 | 10.84 | 10.81 | 10.79 | 10.76 | 10.65 | 10.54 |
| Difenoconazole 3 L ST | 21.74 | 21.68 | 21.63 | 21.58 | 21.51 | 21.30 | 21.09 |
| Metalazyl 4.0 ST | 26.09 | 26.02 | 25.95 | 25.90 | 25.82 | 25.56 | 25.31 |
| Thiabendazole 4 L ST | 7.39 | 7.37 | 7.35 | 7.34 | 7.31 | 7.24 | 7.17 |
| Keystone Solutions Red | 33.91 | 33.82 | 33.74 | 33.66 | 33.56 | 33.23 | 32.90 |
| Colorant | | | | | | | |
| Surfactant | 0.00 | 0.26 | 0.52 | 0.73 | 1.03 | 2.00 | 2.99 |
| Viscosity (initial) | 3100 | 2570 | 2150 | 1707 | 1010 | 520 | 670 |
| Viscosity (30 days) | EEEE | 2770 | 2390 | 1140 | 750 | 696.7 | 756.7 |
| Viscosity (60 days) | EEEE | EEEE | EEEE | EEEE | EEEE | 1647 | 1320 |

TABLE 7
(w/w %)

| | Sample | Sample | Sample | Sample | Sample | Sample | Sample |
|---|---|---|---|---|---|---|---|
| | 1 | 2 | 3 | 4 | 5 | 6 | 7 |
| Macho 600 ST | 15.63 | 15.59 | 15.55 | 15.51 | 15.47 | 15.31 | 15.15 |
| Difenoconazole 3 L ST | 31.25 | 31.17 | 31.09 | 31.02 | 30.93 | 30.62 | 30.30 |
| Metalaxyl 4.0 ST | 9.38 | 9.35 | 9.33 | 9.31 | 9.28 | 9.19 | 9.09 |
| Thiabendazole 4 L ST | 7.81 | 7.79 | 7.77 | 7.75 | 7.73 | 7.65 | 7.58 |
| Rizolex | 9.38 | 9.35 | 9.33 | 9.31 | 9.28 | 9.19 | 9.09 |
| Keystone Treating | 20.31 | 20.26 | 20.21 | 20.16 | 20.11 | 19.90 | 19.70 |
| Solutions Red Colorant | | | | | | | |
| Keystone Solutions | 6.25 | 6.23 | 6.22 | 6.20 | 6.19 | 6.12 | 6.06 |
| Soybean Polymer 604 | | | | | | | |
| Surfactant | 0.00 | 0.25 | 0.50 | 0.74 | 1.02 | 2.02 | 3.03 |
| Viscosity (initial) | 1210 | 1250 | 1197 | 1140 | 1147 | 980 | 693 |
| Viscosity (30 days) | 1817 | 1750 | 1653 | 1543 | 1427 | 1117 | 1607 |
| Viscosity (60 days) | 2473 | 2297 | 2233 | 2497 | 2787 | 2840 | 2870 |

TABLE 8
(w/w %)

| | Sample | Sample | Sample | Sample | Sample | Sample | Sample |
|---|---|---|---|---|---|---|---|
| | 1 | 2 | 3 | 4 | 5 | 6 | 7 |
| Macho 600 ST | 15.63 | 15.59 | 15.55 | 15.51 | 15.47 | 15.31 | 15.15 |
| Difenoconazole 3 L ST | 31.25 | 31.17 | 31.09 | 31.02 | 30.93 | 30.62 | 30.30 |
| Metalaxyl 4.0 ST | 9.38 | 9.35 | 9.33 | 9.31 | 9.28 | 9.19 | 9.09 |
| Thiabendazole 4 L ST | 7.81 | 7.79 | 7.77 | 7.75 | 7.73 | 7.65 | 7.58 |
| Rizolex | 9.38 | 9.35 | 9.33 | 9.31 | 9.28 | 9.19 | 9.09 |
| BASF Color Coat Blue | 20.31 | 20.26 | 20.21 | 20.16 | 20.11 | 19.90 | 19.70 |
| Keystone Solutions | 6.25 | 6.23 | 6.22 | 6.20 | 6.19 | 6.12 | 6.06 |
| Soybean polymer 604 | | | | | | | |
| Surfactant | 0.00 | 0.25 | 0.50 | 0.74 | 1.02 | 2.02 | 3.03 |
| Viscosity (initial) | 1027 | 1050 | 1003 | 943 | 1043 | 993 | 993 |
| Viscosity (30 days) | 1707 | 1667 | 1517 | 1430 | 1497 | 1390 | 1453 |
| Viscosity (60 days) | 2600 | 2390 | 2370 | 1897 | 1670 | 1357 | 1447 |

TABLE 9
(w/w %)

| | Sample | Sample | Sample | Sample | Sample | Sample | Sample |
|---|---|---|---|---|---|---|---|
| | 1 | 2 | 3 | 4 | 5 | 6 | 7 |
| Macho 600 ST | 15.63 | 15.59 | 15.55 | 15.51 | 15.47 | 15.31 | 15.15 |
| Difenoconazole 3 L ST | 31.25 | 31.17 | 31.09 | 31.02 | 30.93 | 30.62 | 30.30 |
| Metalaxyl 4.0 ST | 9.38 | 9.35 | 9.33 | 9.31 | 9.28 | 9.19 | 9.09 |
| Thiabendazole 4 L ST | 7.81 | 7.79 | 7.77 | 7.75 | 7.73 | 7.65 | 7.58 |
| Rizolex | 9.38 | 9.35 | 9.33 | 9.31 | 9.28 | 9.19 | 9.09 |
| BASF Color Coat Green | 20.31 | 20.26 | 20.21 | 20.16 | 20.11 | 19.90 | 19.70 |
| Keystone Solutions | 6.25 | 6.23 | 6.22 | 6.20 | 6.19 | 6.12 | 6.06 |
| Soybean Polymer 604 | | | | | | | |
| Surfactant | 0.00 | 0.25 | 0.50 | 0.74 | 1.02 | 2.02 | 3.03 |
| Viscosity (initial) | 780 | 780 | 800 | 783 | 820 | 770 | 780 |
| Viscosity (30 days) | 2260 | 1840 | 1550 | 1470 | 1537 | 1397 | 1237 |
| Viscosity (60 days) | 2507 | 2380 | 2897 | 2337 | 2130 | 1930 | 1447 |

TABLE 10
(w/w %)

| | Sample | Sample | Sample | Sample | Sample | Sample | Sample |
|---|---|---|---|---|---|---|---|
| | 1 | 2 | 3 | 4 | 5 | 6 | 7 |
| Macho 600 ST | 18.05 | 18.00 | 17.96 | 17.91 | 17.87 | 17.68 | 17.50 |
| Metalaxyl 4.0 ST | 8.02 | 8.00 | 7.98 | 7.96 | 7.94 | 7.86 | 7.78 |
| Rizolex | 7.52 | 7.50 | 7.48 | 7.46 | 7.44 | 7.37 | 7.29 |
| Difenoconazole 3 L ST | 18.80 | 18.75 | 18.70 | 18.66 | 18.61 | 18.42 | 18.23 |
| Keystone Treating | 22.56 | 22.50 | 22.44 | 22.39 | 22.33 | 22.10 | 21.88 |
| Solutions Red Colorant | | | | | | | |
| AMEX 2752 | 25.06 | 25.00 | 24.94 | 24.88 | 24.81 | 24.56 | 24.31 |
| Surfactant | 0.00 | 0.25 | 0.50 | 0.75 | 0.99 | 2.01 | 3.01 |
| Viscosity (initial) | 647 | 703 | 773 | 827 | 977 | 1577 | 2177 |
| Viscosity (30 days) | 840 | 826.7 | 743.3 | 723.3 | 810 | 1120 | 1797 |
| Viscosity (60 days) | 946.7 | 856.7 | 820 | 756.7 | 780 | 1280 | 1800 |

TABLE 11
(w/w %)

| | Sample | Sample | Sample | Sample | Sample | Sample | Sample |
|---|---|---|---|---|---|---|---|
| | 1 | 2 | 3 | 4 | 5 | 6 | 7 |
| Macho 600 ST | 31.45 | 31.37 | 31.29 | 31.21 | 31.13 | 30.81 | 30.50 |
| Metalaxyl 4.0 ST | 6.71 | 6.69 | 6.68 | 6.66 | 6.64 | 6.57 | 6.51 |
| Rizolex | 6.29 | 6.27 | 6.26 | 6.24 | 6.23 | 6.16 | 6.10 |
| Difenoconazole 3 L ST | 15.72 | 15.68 | 15.64 | 15.61 | 15.57 | 15.41 | 15.25 |
| Keystone Treating | 18.87 | 18.82 | 18.77 | 18.73 | 18.68 | 18.49 | 18.30 |
| Solutions Red Colorant | | | | | | | |
| AMEX 2752 | 20.96 | 20.91 | 20.86 | 20.81 | 20.76 | 20.54 | 20.33 |
| Surfactant | 0.00 | 0.25 | 0.50 | 0.75 | 1.00 | 2.01 | 3.01 |
| Viscosity (initial) | 1173 | 1840 | 1997 | 1957 | 2313 | EEEE | EEEE |
| Viscosity (30 days) | 1780 | 2027 | 2040 | 2000 | 2063 | 2180 | 2220 |
| Viscosity (60 days) | 1780 | 1880 | 1903 | 1693 | 1790 | 1777 | 2140 |

TABLE 12
(w/w %)

| | Sample 1 | Sample 2 | Sample 3 | Sample 4 | Sample 5 | Sample 6 |
|---|---|---|---|---|---|---|
| Macho 480 ST | 26.47 | 26.01 | 25.46 | 37.50 | 37.00 | 36.22 |
| Difenoconazole 3 L | 22.06 | 21.68 | 21.22 | 15.63 | 15.42 | 15.09 |
| Metalaxyl 265 ST | 17.65 | 17.34 | 16.97 | 12.5 | 12.33 | 12.07 |
| Thiabendazole 4LSTST | 5.00 | 4.91 | 4.81 | 3.54 | 3.49 | 3.42 |
| Rizolex | 8.82 | 8.67 | 8.49 | 6.25 | 6.17 | 6.04 |
| Surfactant | 2.35 | 4.05 | 6.08 | 2.71 | 4.01 | 6.04 |
| Sensient Green/Blue | 17.65 | 17.34 | 16.97 | 21.88 | 21.58 | 21.13 |
| Viscosity (initial) | 720 | 783 | 1033 | 476 | 686 | 970 |
| Viscosity (120 days) | 1343 | 1560 | 1233 | 510 | 413 | 616 |

Tables 1-12 show measurement of each sample's viscosity three times: initially, at 30 days, and at 60 days or, in the case of Table 12, two times, at 0 and 120 days. Compared to the control which initially measured 1220 cPs and at 60 days almost tripled for an increase of 157%, all of the samples of the inventive seed treatment formulations containing surfactant initially measured lower viscosity upon inclusion of the surfactant, but also showed far less increase in viscosity over time. In other words, not only does the surfactant as described herein reduce viscosity, this reduction is retained over storage time far better than when surfactant of the present invention is not employed. Where the surfactant was present at 0.54% the viscosity increased at 60 days by 27% and where the surfactant was present at 1.1 w/w %, the viscosity increased only 7% at 60 days.

Dust-off of the example formulations was also evaluated. Here, corn was treated with three different seed treatments, each said seed treatment comprising a specified level of a surfactant of FIGS. 1-11 and compared with a control comprising corn treated with the seed treatment with no surfactant. See Table 13 below.

TABLE 13

| | | | APP RATE | |
|---|---|---|---|---|
| | | SURFACTANT % | oz/100 lbs | DUST OFF |
| | TREATMENT | w/w | seed | g/100,000 seeds |
| Corn | Macho 480 | 0 | 0 | .6809 |
| Corn | Macho 480 | 2 | 7.5 | .1851 |
| Corn | Macho 600 | 0 | 0 | .7338 |
| Corn | Macho 600 | 2.4 | 6 | .1878 |
| Corn | Untreated | 0 | N/A | .0628 |
| Corn | Cruiser | 0 | 1.33 | .4075 |
| Corn | Cruiser | 1.00 | 1.34 | .3768 |
| Corn | Cruiser | 2.00 | 1.35 | .3118 |
| Corn | Cruise | 3.00 | 1.36 | .2049 |
| Corn | Cruise | 4.00 | 1.38 | .0721 |
| Corn | Macho 480 only | 0 | 7.5 | .6809 |
| Corn | Macho 480 + soprophor4D-360 | 2 | 7.5 | .1077 |
| Corn | Macho 480 + emulsion AG13A | 2 | 7.5 | .0728 |
| Corn | Macho480 + STEPFAC TSP-PE-K | 2 | 7.5 | .1488 |
| Corn | Macho600 only | 0 | 6 | .7338 |
| Corn | Macho 600 + soprophor 4D-360 | 2.4 | 6 | .1640 |
| Corn | Macho 600 + emulsion AG13A | 2.4 | 6 | .0910 |
| Corn | Macho600 + STEPFAC TSP-pE-K | 2.4 | 6 | .1470 |

In short, the addition of a surfactant of a structure shown in FIGS. 1-11 markedly reduced dust off. When one of said surfactants was used at 2.0% w/w with Macho 480, dust off compared with dust off of Macho 480 alone was reduced from average 0.6809 to 0.1851 g/100,000 seed; when used at 2.4% w/w with Macho 600 the average dust off reduction was from 0.7338 to 0.1878; and, finally, when used at several different concentrations with Cruiser average dust off was reduced from 0.4075 with no inventive surfactant included, to 0.0721 at 4.00% w/w surfactant inclusion.

Seed safety was evaluated by conducting warm seed germination testing. Germination rates are summarized below in Tables 14-24. Germination of seed of several crops were compared. Specifically, germination rates of soybeans, corn, lentils, peas, chickpea, wheat, barley, oats, triticale, rice and cotton were studied. Seed treated with a seed treatment including the surfactant of the present invention were compared with seeds treated with a control seed treatment. The data shows no statistical differences in the germination rates of seeds treated with seed treatments of the present invention as compared to those treated with control seed treatment.

TABLE 14
Crop: Soybean
Storage Temperature: 25 C.

| | | Time Point | | |
|---|---|---|---|---|
| | | Initial | 7 Day | 2 Month |
| | Warm | Mean | Mean | Mean |
| Sample | Treatment | Norm | Norm | Norm |
| Sample 1 | control | 96 | 94 | 95 |
| Sample 2 | Surfactant 0.05 fl oz/100 lbs | 96 | 94 | 94 |
| Sample 3 | Surfactant 0.10 fl oz/100 lbs | 96 | 94 | 91 |
| Sample 4 | Surfactant 0.20 fl oz/100 lbs | 96 | 94 | 91 |
| Sample 5 | Surfactant 0.40 fl oz/100 lbs | 96 | 95 | 94 |
| Sample 6 | Surfactant 1:1 with DI H2O | 95 | 94 | 95 |

TABLE 15
Crop: Corn
Storage Temperature: 25 C.

| | | Time Point | | |
|---|---|---|---|---|
| | | Initial | 7 Day | 2 Month |
| | Warm | Mean | Mean | Mean |
| Sample | Treatment | Norm | Norm | Norm |
| Sample 1 | control | 94 | 95 | 95 |
| Sample 2 | Surfactant 0.05 fl oz/100 lbs | 95 | 96 | 95 |
| Sample 3 | Surfactant 0.10 fl oz/100 lbs | 96 | 95 | 93 |
| Sample 4 | Surfactant 0.20 fl oz/100 lbs | 96 | 95 | 96 |
| Sample 5 | Surfactant 0.40 fl oz/100 lbs | 95 | 95 | 93 |
| Sample 6 | Surfactant 1:1 with DI H2O | 94 | 94 | 94 |

TABLE 16
Crop: Lentils
Storage Temperature: 20 C.

| | | Time Point | | |
|---|---|---|---|---|
| | | Initial | 7 Day | 2 Month |
| | Warm | Mean | Mean | Mean |
| Sample | Treatment | Norm | Norm | Norm |
| Sample 1 | control | 79 | 85 | 76 |
| Sample 2 | Surfactant 0.05 fl oz/100 lbs | 82 | 90 | 76 |
| Sample 3 | Surfactant 0.10 fl oz/100 lbs | 81 | 87 | 80 |
| Sample 4 | Surfactant 0.20 fl oz/100 lbs | 80 | 92 | 78 |
| Sample 5 | Surfactant 0.40 fl oz/100 lbs | 80 | 92 | 71 |
| Sample 6 | Surfactant 1:1 with DI H2O | 80 | 92 | 75 |

TABLE 17
Crop: Peas
Storage Temperature: 20 C.

| | | Time Point | | |
|---|---|---|---|---|
| | | Initial | 7 Day | 2 Month |
| | Warm | Mean | Mean | Mean |
| Sample | Treatment | Norm | Norm | Norm |
| Sample 1 | control | 65 | 61 | 62 |
| Sample 2 | Surfactant 0.05 fl oz/100 lbs | 67 | 62 | 68 |
| Sample 3 | Surfactant 0.10 fl oz/100 lbs | 63 | 62 | 61 |
| Sample 4 | Surfactant 0.20 fl oz/100 lbs | 63 | 62 | 61 |
| Sample 5 | Surfactant 0.40 fl oz/100 lbs | 64 | 61 | 61 |
| Sample 6 | Surfactant 1:1 with DI H2O | 64 | 63 | 67 |

TABLE 18
Crop: Chickpea
Storage Temperature: 20 C.

| | | Time Point | | |
|---|---|---|---|---|
| | | Initial | 7 Day | 2 Month |
| | Warm | Mean | Mean | Mean |
| Sample | Treatment | Norm | Norm | Norm |
| Sample 1 | control | 86 | 86 | 86 |
| Sample 2 | Surfactant 0.05 fl oz/100 lbs | 84 | 88 | 87 |
| Sample 3 | Surfactant 0.10 fl oz/100 lbs | 87 | 87 | 88 |
| Sample 4 | Surfactant 0.20 fl oz/100 lbs | 85 | 88 | 86 |
| Sample 5 | Surfactant 0.40 fl oz/100 lbs | 82 | 90 | 90 |
| Sample 6 | Surfactant 1:1 with DI H2O | 81 | 88 | 90 |

TABLE 19
Crop: Wheat
Storage Temperature: 20 C.

| | | Initial | 7 Day | 2 Month |
|---|---|---|---|---|
| | Warm | Mean | Mean | Mean |
| Sample | Treatment | Norm | Norm | Norm |
| Sample 1 | control | 90 | 87 | 91 |
| Sample 2 | Surfactant 0.05 fl oz/100 lbs | 93 | 88 | 95 |
| Sample 3 | Surfactant 0.10 fl oz/100 lbs | 91 | 89 | 93 |
| Sample 4 | Surfactant 0.20 fl oz/100 lbs | 90 | 84 | 94 |
| Sample 5 | Surfactant 0.40 fl oz/100 lbs | 92 | 84 | 90 |
| Sample 6 | Surfactant 1:1 with DI H2O | 91 | 80 | 79 |

TABLE 20
Crop: Barley
Storage Temperature: 20 C.

| | | Time Point | | |
|---|---|---|---|---|
| | | Initial | 7 Day | 2 Month |
| | Warm | Mean | Mean | Mean |
| Sample | Treatment | Norm | Norm | Norm |
| Sample 1 | control | 99 | 99 | 98 |
| Sample 2 | Surfactant 0.05 fl oz/100 lbs | 98 | 99 | 99 |
| Sample 3 | Surfactant 0.10 fl oz/100 lbs | 99 | 99 | 98 |
| Sample 4 | Surfactant 0.20 fl oz/100 lbs | 97 | 99 | 98 |
| Sample 5 | Surfactant 0.40 fl oz/100 lbs | 97 | 99 | 98 |
| Sample 6 | Surfactant 1:1 with DI H2O | 98 | 99 | 98 |

TABLE 21
Crop: Oats
Storage Temperature: 20 C.

| | | Time Point | | |
|---|---|---|---|---|
| | | Initial | 7 Day | 2 Month |
| | Warm | Mean | Mean | Mean |
| Sample | Treatment | Norm | Norm | Norm |
| Sample 1 | control | 97 | 99 | 99 |
| Sample 2 | Surfactant 0.05 fl oz/100 lbs | 97 | 99 | 99 |
| Sample 3 | Surfactant 0.10 fl oz/100 lbs | 97 | 98 | 98 |
| Sample 4 | Surfactant 0.20 fl oz/100 lbs | 97 | 97 | 98 |
| Sample 5 | Surfactant 0.40 fl oz/100 lbs | 96 | 97 | 96 |
| Sample 6 | Surfactant 1:1 with DI H2O | 97 | 98 | 98 |

TABLE 22
Crop: Triticale
Storage Temperature: 20 C.

| | | Time Point | | |
|---|---|---|---|---|
| | | Initial | 7 Day | 2 Month |
| | Warm | Mean | Mean | Mean |
| Sample | Treatment | Norm | Norm | Norm |
| Sample 1 | control | 89 | 85 | 88 |
| Sample 2 | Surfactant 0.05 fl oz/100 lbs | 88 | 85 | 90 |
| Sample 3 | Surfactant 0.10 fl oz/100 lbs | 85 | 87 | 84 |
| Sample 4 | Surfactant 0.20 fl oz/100 lbs | 85 | 82 | 89 |
| Sample 5 | Surfactant 0.40 fl oz/100 lbs | 87 | 87 | 87 |
| Sample 6 | Surfactant 1:1 with DI H2O | 86 | 81 | 86 |

TABLE 23
Crop: Rice
Storage Temperature: 20-30 C.

| | | Time Point | | |
|---|---|---|---|---|
| | | Initial | 7 Day | 2 Month |
| | Warm | Mean | Mean | Mean |
| Sample | Treatment | Norm | Norm | Norm |
| Sample 1 | control | 87 | 82 | 84 |
| Sample 2 | Surfactant 0.05 fl oz/100 lbs | 85 | 81 | 83 |
| Sample 3 | Surfactant 0.10 fl oz/100 lbs | 81 | 82 | 81 |
| Sample 4 | Surfactant 0.20 fl oz/100 lbs | 83 | 80 | 86 |
| Sample 5 | Surfactant 0.40 fl oz/100 lbs | 83 | 73 | 80 |
| Sample 6 | Surfactant 1:1 with DI H2O | 84 | 79 | 81 |

TABLE 24
Crop: Cotton
Storage Temperature: 30 C.

| | | Time Point | | |
|---|---|---|---|---|
| | | Initial | 7 Day | 2 Month |
| | Warm | Mean | Mean | Mean |
| Sample | Treatment | Norm | Norm | Norm |
| Sample 1 | control | 53 | 55 | 73 |
| Sample 2 | Surfactant 0.05 fl oz/100 lbs | 64 | 69 | 83 |
| Sample 3 | Surfactant 0.10 fl oz/100 lbs | 60 | 74 | 76 |
| Sample 4 | Surfactant 0.20 fl oz/100 lbs | 67 | 65 | 64 |
| Sample 5 | Surfactant 0.40 fl oz/100 lbs | 65 | 76 | 84 |
| Sample 6 | Surfactant 1:1 with DI H2O | 62 | 67 | 61 |

Suitable Surfactants

Suitable surfactants for the subject invention may include a mixture of polyoxyethylated alkaryls, or mixed alkaryl ethoxylates and, as a particular example, may comprise ethoxylated styrenated phenol alkoxylate, polyarylphenol ethoxylates, ethoxylated polyphenyl ether phosphate and their salts and alkylated tristyrlphenols as well as mono- di- and tri-styrenated phenols and mixtures thereof, and perform similarly to a dispersant in agrichemical seed treatment formulations. When incorporated into custom blends, the surfactants suitable for use in the agrichemical seed treatment formulations of the subject invention unexpectedly have an average molecular weight of between 600-1500, preferably in the 1000-1200, up to around 2,000 or even higher into the 10,000 range. Most of the range is lower than surfactants used in other commercially employed seed treatments. Further, these surfactants have been observed to be more user friendly and increase the stability of the seed treatment formulation custom blend over time. They contain ethylene oxide chain lengths of anywhere from 5-50 mols, mols, desirably in the 10-20 mol ranges and may be exemplified by the structures shown at FIGS. 1-11. These surfactants contain a solids loading of 40.00-100.00% weight by weight with the balance being either water or a mixture of water and glycols. The surfactants employed in the present invention exhibit HLB ranges from about 6 to about 25. Hydrophile-Lipophile Balance (HLB) is an empirical expression for the relationship of the hydrophilic (“water-loving”) and hydrophobic (“water-hating”) groups of a surfactant. The higher the HLB value, the more water-soluble the surfactant. These surfactants may exhibit hydroxyl values from 30 to 80 and may comprise, but are not limited to a mixture of polyoxyethylated alkaryls, or mixed alkaryl ethoxylates and, as a particular example, may comprise ethoxylated styrenated phenol alkoxylate, polyarylphenol ethoxylates, ethoxylated polyphenyl ether phosphate and their salts and alkylated tristyrlphenols generally referred to as tristyrylphenol ethoxylates. Styrenated phenol ethoxylates comprise characteristics indicating efficacy as a surfactant in the present invention. FIGS. 1-11 shows molecular structure of suitable surfactants.

Examples of surfactants well-suited for use in the present invention may include but are not limited to one or more of the following types of compounds or their equivalents: Soprophor TS/10, Soprophor BSU, Soprophor CY/8, Soprophor S/25, Soprophor S-40, Soprophor TS/60, Soprophor 3D-33, Soprophor 3D-22/LN, Soprophor FLK, Soprophor FL, Soprophor FL-60, Soprophor 4D-484, Soprophor 4D-36 from Solvay; Ethox 4018, Ethox 4019, Ethox 4467, and Ethox 4402 from Ethox LLC. Termul 3150 and Termul 3115 from Huntsman. STEPFAC TSP-PE-K, STEPFAC TSP-PE-N, STEPFAC TSP-PE, MAKON TSP-12, MAKON TSP-16, MAKON TSP-20, MAKON TSP-25, MAKON TSP-40, and MAKON TSP-60 from Stepan. EMULSON AG 7710A, EMULSON AG 7717A, EMULSON AG 7720A, EMULSON AG 7725A, EMULSON AG 7740A, EMULSON AG 7754A, EMULSON AG 8A, EMULSON AG 13A, EMULSON AG 17A, EMULSON AG TRS 204 from Lamberti. Emulsogen TS 100, Emulsogen TS 160, Emulsogen TS 200, Emulsogen TS 290, Emulsogen TS 540, Emulsogen TS 600 from Clariant.

Active Ingredients

The invention is based upon using surfactants meeting the characteristics as disclosed herein in formulations. The formulations may also comprise one or more of a number of active ingredients or agrichemicals, including but not limited to one or more of the following ingredients. Or, the formulations may include one or more of the active ingredients in multiple combinations to create Custom Blends with the active ingredients listed alphabetically below.

Benzimidazole Fungicides—Such as Albendazole, Benomyl, Carbendazim, Chlorfenazole, Cypendazole, Debacarb, Fuberidazole, Mecarbinzid, Rabenzazole, Thiabendazole, Thiophanate, and Thiophanate-methyl.

Dithiocarbamate Fungicides—Such as amobam, asomate, azithiram, carbamorph, cufraneb, cuprobam, disulfiram, ferbam, metam, nabam, tecoram, thiram, urbacide, and ziram.

Neonicotinoid Insecticides—Such as, Acetamiprid, Clothianidin, Dinotefuran, Imidacloprid, Nithiazine, Thiacloprid and Thiamethoxam.

Organophosporus Insecticides—Such as Acephate, Azamethiphos, Azinphos Methyl, Chlorpyrifos, Diazinon, Dichlorvos, Fenitrothion, Malathion, Methyl Parathion, Parathion, Phosmet, Tetrachlorvinphos.

Organophosphorus Fungicides—Such as Ampropylfos, Ditalimos, Edifenphos, Fosetyl, Inezin, Iprobenfos, Izoamfos, Phosdipen, Pyrazopos, Toclofos-Ethyl, and Triamiphos.

Oxathiin Fungicides—Such as Caroboxin and Oxathiin

Phenylamide Fungicides—Such as Metalaxyl, Metalaxyl-M

Phenylpyrrole Fungicides—Such as Dimetachlone, Fludioxonil, Fenpiclonil, and Fluroimide

Phthalimide Fungicides—Such as Captafol, Captan, Ditalimfos, Folpet, and Thiochlorofenphim.

Triazole Fungicides—Such as Azaconazole, Bromuconazole, Cyproconazole, Diclobutrazol, Difenoconazole, Diniconazolke, Etaconazole, Epoxiconazole, Fenbuconazole, Fluquinconazole, Flutriafol, Furconazole, Hexaconazole, Imibenconazole, Ipconazole, Metconazole, Myclonutanil, Penaconazole, Prothioconazole Propiconazole, Tebuconazole, Quinconazole, Simeconazole, Tetraconazole, Triadimefon, Triadimenol, Triticonazole, and Uniconazole.

Strobilurin Fungicides—Such as Azoxystrobin, Coumoxystrobin, Dimoxystrobin, Enoxastrobin, Fenaminstrobin, Flufenoxystrobin, Fluoxastrobin, Mandestrobin, Metominoistrobin, Orysastrobin, Picoxystrobin, and Pyaoxystrobin, Pyraclostrobin, Pyrametostobin, Pyrametostrobin, and Trifloxystrobin.

The present invention comprises a method of treating seeds and a seed treatment formulation. The method comprises treating seeds with a seed treatment formulation that includes at least one agrichemical (active ingredient) and a surfactant. Generally, the at least one agrichemical may include a pesticide, a fungicide, or an insecticide as listed above or a mixture thereof. One method comprises treating seeds with a seed treatment formulation comprising between about 0.10% and about 5% w/w said surfactant. Another employs a formulation comprising between about 0.10% w/w/and about 10% w/w of the surfactant or blend of surfactants of the present invention or a blend comprising at least one surfactant of the present invention and at least one other surfactant or co-emulsifier. The seed treatment of the present invention is formulated so as to minimize dust off. In some embodiments, the seed treatment is applied at a rate of less than 1.5 oz/100 lbs of seed where said seed treatment formula includes between about 1% and about 5% w/w of the surfactant. In another embodiment, an application rate of about 7.5 oz/100 pounds of seed is employed for a commercial seed treatment formula comprising about 2% to about 3% w/w of the surfactant. The method includes seed treatment for providing a level of pesticide protection to the seeds treated without significantly decreasing the seed's expected germination rate as is demonstrated at Tables 14-24. And, finally, the seed treatment of the present invention may be formulated not only to reduce viscosity upon formulation but to retain a lower viscosity over time for ease of use and advantageous storage possibilities (see Tables 1-12).

From the foregoing, it will be seen that this invention is one well adapted to attain all the ends and objects set forth above, together with other advantages, which are obvious and inherent to the seed treatment and method of using the seed treatment. It will be understood that certain features and subcombinations are of utility and may be employed without reference to other features and subcombinations. This is contemplated by and is within the scope of the claims.

1. A composition having reduced viscosity comprising one or more agrochemicals and at least one surfactant selected from the group consisting of monostyrylphenol ethoxylate, distyrylphenol ethoxylate, tristyrylphenol ethoxylate, monostyrenated phenol ethoxylate, distyrenated phenol ethoxylate, and tristyrenated phenol ethoxylate.

2. The composition of claim 1, wherein at least one of said at least one surfactants is a compound of the formula: 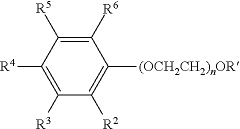
wherein R¹ is one of H, SO₃⁻, R⁷, H2PO₃, or HPO₃(R⁷) and each of R², R³, R⁴, R⁵, and R⁶ are independently selected from a group consisting of H, or a group of the formula: 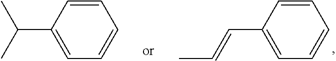
and R⁷ is a base or a counterion.

3. The composition of claim 2 wherein each of R², R³, R⁴, R⁵, and R⁶ are the same for at least one of said at least one surfactant.

4. The composition of claim 2 wherein none of R², R³, R⁴, R⁵, and R⁶ are the same for at least one of said at least one surfactant.

5. The composition of claim 2 wherein at least two of R², R³, R⁴, R⁵, and R⁶ are the same for at least one of said at least one surfactant.

6. The composition of claim 2, wherein each of said at least one surfactant is selected from a group consisting of compounds of the structures shown in FIGS. 1-11.

7. The composition of claim 2, said at least one surfactant comprising molecular weight between about 500 and about 10,000.

8. The composition of claim 2, said at least one of said surfactant containing ethylene oxide chain lengths of between about 10 and about 60 mols.

9. The composition of claim 2, wherein said at least one surfactant comprises between about 0.1 to 100 weight percent surfactant.

10. The composition of claim 2, wherein said at least one surfactant comprises an HLB range from about 4 to about 18.

11. The composition of claim 1, wherein at least one said surfactant comprises a styrenated phenol ethoxylate.

12. The composition of claim 1, wherein the styrenated phenol ethoxylate optionally contains from 0 to 50 mols of polypropylene oxide.

13. The composition of claim 1, wherein at least one of said one or more agrochemicals is selected from a group consisting of a neonicotinoid insecticide, a phenylamide fungicide, a phenylpyrrole fungicide, a triazole fungicide, an organophosphorus fungicide, an organophosporus insecticide, a strobilurin fungicide, a phthalimide fungicide, an oxathiin fungicide, a dithiocarbamate fungicide, or a biological pesticide.

14. The composition of claim 13 at least one of said one or more agrochemical selected from the group consisting of Imidacloprid, Acetamiprid, Clothianidin, Dinotefuran, Nithiazine, Thiacloprid, Thiamethoxam, Metalaxyl, Metalaxyl-M, Fludioxonil, Dimetachlone, Fenpiclonil, Fluroimide, Albendazole, Benomyl, Carbendazim, Chlorfenazole, Cypendazole, Debacarb, Fuberidazole, Mecarbinzid, Rabenzazole, Thiabendazole, Thiophanate, Thiophanate-methyl, Epoxiconazole, Triadimenol, Propiconazole, Metconazole, Cyproconazole, Tebuconazole, Azaconazole, Bromuconazole, Diclobutrazol, Difenoconazole, Diniconazolke, Etaconazole, Fenbuconazole, Fluquinconazole, Flutriafol, Furconazole, Hexaconazole, Imibenconazole, Ipconazole, Myclonutanil, Penaconazole, Prothioconazole, Quinconazole, Simeconazole, Tetraconazole, Triadimefon, Triticonazole, Uniconazole, Ampropylfos, Ditalimos, Edifenphos, Fosetyl, Inezin, Iprobenfos, Izoamfos, Phosdipen, Pyrazopos, Toclofos-Ethyl, Triamiphos, Parathion, Acephate, Malathion, Methyl Parathion, Chlorpyrifos, Diazinon, Dichlorvos, Phosmet, Fenitrothion, Tetrachlorvinphos, Azamethiphos, and Azinphos Methyl, Fluoxastrobin, Mandestrobin, Azoxystrobin, Coumoxystrobin, Enoxastrobin, Flufenoxystrobin, Picoxystrobin, and Pyaoxystrobin, Pyraclostrobin, Pyrametostobin, Pyrametostrobin, Dimoxystrobin, Fenaminstrobin, Metominoistrobin, Orysastrobin, Trifloxystrobin, Captafol, Captan, Ditalimfos, Folpet, Thiochlorofenphim, Carboxin, Oxycaroboxin, Amobam, Asomate, Azithiram, Carbamorph, Cufraneb, Cuprobam, Disulfiram, Ferbam, Metam, Nabam, Tecoram, Thiram, Urbacide, or Ziram.

15. The composition of claim 1, wherein said one or more agrochemical comprises at least one selected from the group consisting of Imidacloprid, Acetamiprid, Clothianidin, Dinotefuran, Nithiazine, Thiacloprid, Thiamethoxam, Metalaxyl, Metalaxyl-M, Fludioxonil, Dimetachlone, Fenpiclonil, Fluroimide, Albendazole, Benomyl, Carbendazim, Chlorfenazole, Cypendazole, Debacarb, Fuberidazole, Mecarbinzid, Rabenzazole, Thiabendazole, Thiophanate, Thiophanate-methyl, Epoxiconazole, Triadimenol, Propiconazole, Metconazole, Cyproconazole, Tebuconazole, Azaconazole, Bromuconazole, Diclobutrazol, Difenoconazole, Diniconazolke, Etaconazole, Fenbuconazole, Fluquinconazole, Flutriafol, Furconazole, Hexaconazole, Imibenconazole, Ipconazole, Myclonutanil, Penaconazole, Prothioconazole, Quinconazole, Simeconazole, Tetraconazole, Triadimefon, Triticonazole, Uniconazole, Ampropylfos, Ditalimos, Edifenphos, Fosetyl, Inezin, Iprobenfos, Izoamfos, Phosdipen, Pyrazopos, Toclofos-Ethyl, Triamiphos, Parathion, Acephate, Malathion, Methyl Parathion, Chlorpyrifos, Diazinon, Dichlorvos, Phosmet, Fenitrothion, Tetrachlorvinphos, Azamethiphos, and Azinphos Methyl, Fluoxastrobin, Mandestrobin, Azoxystrobin, Coumoxystrobin, Enoxastrobin, Flufenoxystrobin, Picoxystrobin, and Pyaoxystrobin, Pyraclostrobin, Pyrametostobin, Pyrametostrobin, Dimoxystrobin, Fenaminstrobin, Metominoistrobin, Orysastrobin, Trifloxystrobin, Captafol, Captan, Ditalimfos, Folpet, Thiochlorofenphim, Carboxin, Oxycaroboxin, Amobam, Asomate, Azithiram, Carbamorph, Cufraneb, Cuprobam, Disulfiram, Ferbam, Metam, Nabam, Tecoram, Thiram, Urbacide, or Ziram.

16. The composition of claim 1 wherein said one or more agrochemical includes at least one of a pesticide, fungicide or insecticide.

17. The composition of claim 1, comprising said one or more agrochemical at between about 0.1% and about 99% w/w and said at least one surfactant at between about 0.10% and about 10% w/w.

18. A method of reducing the viscosity of a seed treatment wherein the method comprises the step of mixing a surfactant comprising at least one tristyrylphenol ethoxylate into the seed treatment.

19. The method of claim 17, wherein at least one said tristyrylphenol ethoxylate surfactant is a compound of the formula: 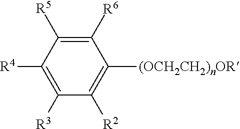
wherein R¹ is one of H, SO₃⁻X⁺, H2PO₃ or HPO₃(R⁷); and R², R³, R⁴, R⁵, R⁶ are each selected from a group consisting of H, or a group of the formula: 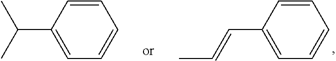
and R⁷ is a base or a counterion.

20. The method of claim 18, wherein at least one said tristyrylphenol ethoxylate surfactant is selected from the group consisting of compounds of the structures shown in FIGS. 1-11.

21. The method of claim 18, wherein the seed treatment and tristyrylphenol ethoxylate surfactant mixture comprises an initial viscosity between about 800 cPs and about 1100 cPs and a 60-day viscosity between about 850 cPs and about 1700 cPs.

22. A seed treatment composition having dusting-off reduced to no more than 0.75 g/100,000 seeds, said seed treatment composition comprising one or more agrochemicals and at least one tristyrylphenol ethoxylate surfactant.

23. The composition of claim 22, further comprising at least one of another surfactant and a coemulsifier wherein the at least one tristyrylphenol ethoxylate surfactant is a compound of the formula: 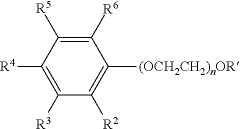
wherein R¹ is one of a group consisting of H, SO₃⁻X⁺, H2PO₃, or HPO₃(R⁷) and R², R³, R⁴, R⁵, R⁶ are selected from a group consisting of H, or a group of the formula: 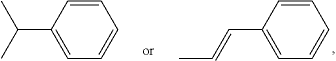
and R⁷ is a base or a counterion.

24. The composition of claim 22, wherein the at least one tristyrylphenol ethoxylate surfactant is selected from the group consisting of compounds of the structures shown in FIGS. 1-11.

25. The composition of claim 22, wherein at least one of said one or more agrochemical is a neonicotinoid insecticide, a phenylamide fungicide, a phenylpyrrole fungicide, a triazole fungicide, an organophosphorus fungicide, an organophosporus insecticide, a strobilurin fungicide, a phthalimide fungicide, an oxathiin fungicide, a dithiocarbamate fungicide, or a biological pesticide.

26. The composition of claim 22, wherein at least one of said one or more agrochemical is selected from the group consisting of Imidacloprid, Acetamiprid, Clothianidin, Dinotefuran, Nithiazine, Thiacloprid, Thiamethoxam, Metalaxyl, Metalaxyl-M, Fludioxonil, Dimetachlone, Fenpiclonil, Fluroimide, Albendazole, Benomyl, Carbendazim, Chlorfenazole, Cypendazole, Debacarb, Fuberidazole, Mecarbinzid, Rabenzazole, Thiabendazole, Thiophanate, Thiophanate-methyl, Epoxiconazole, Triadimenol, Propiconazole, Metconazole, Cyproconazole, Tebuconazole, Azaconazole, Bromuconazole, Diclobutrazol, Difenoconazole, Diniconazolke, Etaconazole, Fenbuconazole, Fluquinconazole, Flutriafol, Furconazole, Hexaconazole, Imibenconazole, Ipconazole, Myclonutanil, Penaconazole, Prothioconazole, Quinconazole, Simeconazole, Tetraconazole, Triadimefon, Triticonazole, Uniconazole, Ampropylfos, Ditalimos, Edifenphos, Fosetyl, Inezin, Iprobenfos, Izoamfos, Phosdipen, Pyrazopos, Toclofos-Ethyl, Triamiphos, Parathion, Acephate, Malathion, Methyl Parathion, Chlorpyrifos, Diazinon, Dichlorvos, Phosmet, Fenitrothion, Tetrachlorvinphos, Azamethiphos, and Azinphos Methyl, Fluoxastrobin, Mandestrobin, Azoxystrobin, Coumoxystrobin, Enoxastrobin, Flufenoxystrobin, Picoxystrobin, and Pyaoxystrobin, Pyraclostrobin, Pyrametostobin, Pyrametostrobin, Dimoxystrobin, Fenaminstrobin, Metominoistrobin, Orysastrobin, Trifloxystrobin, Captafol, Captan, Ditalimfos, Folpet, Thiochlorofenphim, Carboxin, Oxycaroboxin, Amobam, Asomate, Azithiram, Carbamorph, Cufraneb, Cuprobam, Disulfiram, Ferbam, Metam, Nabam, Tecoram, Thiram, Urbacide, or Ziram.

27. The composition of claim 22, wherein each of said at least one or more agrochemical is present at between about 0.1% and about 99% w/w and said at least one tristyrylphenol ethoxylate surfactant comprises between about 0.10% and about 10% w/w of the composition.

28. A method of reducing dusting-off of treated seeds wherein the method comprises the steps of:
a. First mixing at least one surfactant selected from the group consisting of monostyrylphenol ethoxylate, distyrylphenol ethoxylate, and tristyrylphenol ethoxylate into a seed treatment to form a mixture; and
b. Then treating seed with the mixture, resulting in dust-off no more than 0.75 grams/100,000 seeds.

29. The method of claim 28, wherein at least one of said at least one surfactant is a tristyrylphenol ethoxylate surfactant of the formula: 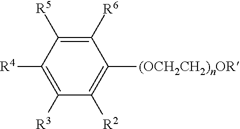
wherein R¹ is H, SO₃⁻X⁺, H2PO₃, or HPO₃(R⁷) and R², R³, R⁴, R⁵, R⁶ are independently H or a group of the formula: 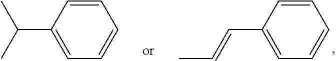
and R⁷ is a base or a counterion.

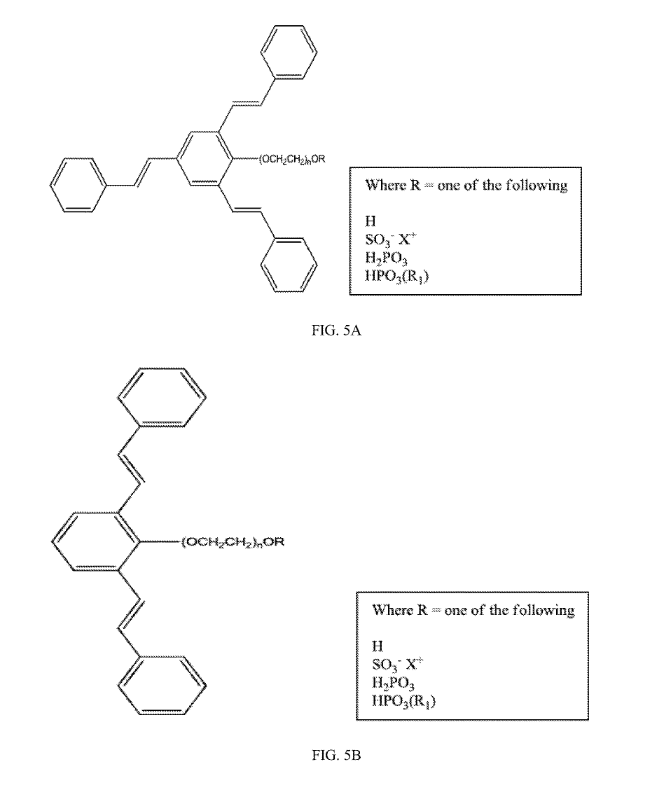

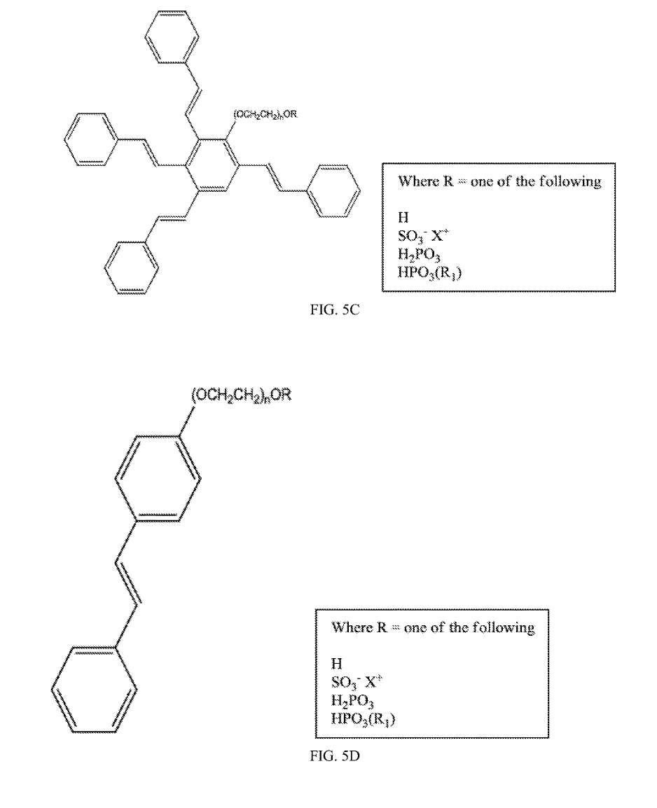

30. The method of claim 28, wherein at least one of said at least one surfactant is a tristyrylphenol ethoxylate surfactant selected from the group consisting of compounds of the structures shown in FIG. 5.

31. The seed treatment of claim 1 wherein when applied to seed, the seed treatment results in a dust off rate of no more than 0.75 g/100,000 seeds.

32. The composition of claim 2, said at least one surfactant comprising molecular weight between about 500 and 2000.

33. The composition of claim 1 further comprising at least two of said at least one surfactant.

34. The composition of claim 1 further comprising at least one coemulsifier.

35. The composition of claim 1, wherein at least one of said at least one surfactants is a compound of the formula: 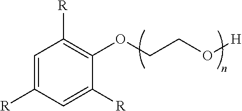
Wherein n=5 to 25 and R is H, CH(CH₃)(C₆H₅), or

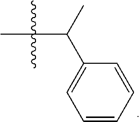 [SMILES: *C(C)c1ccccc1]

36. The composition of claim 2, wherein said at least one surfactant comprises an HLB range from about 9 to about 14.
